(19) United States
(12) Patent Application Publication
(10) Pub. No.: US 2006/0164312 A1
(43) Pub. Date: Jul. 27, 2006

(54) Capacitive antenna and method for making same

(76) Inventor: Christophe Mathieu, Poissy (FR)

Correspondence Address: HARRINGTON & SMITH, LLP, 4 RESEARCH DRIVE, SHELTON, CT, 06484-6212, US

(21) Appl. No.: 10/521,822

(22) PCT Filed: Jul. 24, 2003
(86) PCT No.: PCT/FR03/50020

§ 371 Date: Jul. 8, 2005

(30) Foreign Application Priority Data
Jul. 25, 2002 (FR) 0209462

(51) Int. Cl. H01Q 7/00

(52) U.S. Cl. 343/748; 343/749; 343/866

(57) ABSTRACT

The invention concerns a method for making a capacitive antenna (4) by performing a gravure process on the antenna comprising a single turn (9) connected to a capacitor (10), the turn and the capacitor being printed by a gravure process with a conductive ink. The use of a dielectric ink for the gravure process also enables a dielectric thickness (16) to be obtained between two conductive electrodes (14, 17) printed by gravure process. The capacitance of the capacitor is determined on the basis of the antenna inductance, the frequency of communication and the law of resonance whereto a chip (3) connected to said antenna (4) is subjected.

The subject of the present invention is a capacitive antenna and a production process for such an antenna. It is more particularly used in the field of applications related to wireless communication technologies, notably to radiofrequency identification (RFID) applications. These applications are implemented, for example, for automatic identification and transmission of data in the fields of access control as well as electronic data management. With regard to access control and/or electronic cashiers, applications include, for example, public transportation ticketing, highway tolls, parking tickets, airplane tickets, etc. Numerous companies have also developed identification means for their personnel or their clientele, by means of a contact-free chip.

Currently there are two principal frequency bands used for applications of identification by radio frequency: low frequencies at around 125 kHz and medium frequencies at around 13.56 MHz. The values of these frequencies are generally fixed and correspond to international standards. In order to implement this technology, a reading device capable of communicating with a mobile device carried by a user is principally used. Communication is conducted by remote electromagnetic coupling between an antenna housed in the mobile device and a second antenna positioned in the reading device.

The mobile device, or transponder, generally has a support on which are present an electronic device to create, store and process data, for example, a chip, and the first antenna with which the device is linked. It is also generally present in the form of an ISO format credit card or a flexible label (“tag”).

Overall, the price of a chip is proportional to the silicon surface used to house the microprocessor, the memory zones and the capacitors. In order to significantly lower the cost of the antenna and the micropackaging of the chip, it is known in the prior art to try to reduce the size of the chip by reducing the space taken up by the capacitors. Therefore, chips having smaller capacitors and lower capacitances are used.

Consequently, in parallel with the reduction of the size of the chip, at constant antenna inductance, it becomes necessary for the support to also have another capacitor so that the resonance law of the device is respected. The optimal functioning of the device is obtained at resonance when the characteristics of different components of this device respect the following law of resonance:
LₐCₚω²=1 wherein

Lₐ corresponds to the antenna inductance,

Cₚ corresponds to the capacitance of the device, and

ω=2πf corresponds to the pulsation and is calculated as a function of the frequency (f) chosen for the signal exchange.

As is described in document WO-A-01/50547, providing a second capacitor in parallel with the chip and the antenna is known. This second capacitor permits compensating for the fact that the capacitance of the chip is reduced. Notably, this document teaches screen printing the capacitor in the same way that the antenna is screen printed.

Screen printing is derived from the technique of mask printing. It involves a process of printing by means of a screen made up of a frame onto which a mesh cloth is attached. The cloth is generally made up of synthetic fibers such as nylon or polyester. This screen, applied onto the support, receives the ink which, pressed by a squeegee, passes through the open mesh to create the impression. The thickness of the printed deposit is irregular.

The devices of the prior art pose a problem. In fact, they permit using smaller and, therefore, less expensive chips, but in contrast, these devices impose certain constraints on the creation of the antenna. The antenna is screen printed onto a support. Generally, the antenna has several loops so that the first contact zone of the antenna is found inside the loops, while the second contact zone of the antenna is found outside the loops. To connect the chip and the second capacitor in parallel to the antenna, it is necessary to connect the capacitor to each of the two contact zones of the antenna.

The problem is essentially posed in the prior art by the fact that the antenna must have several loops, given the capacitances of the capacitors and the resonance law to be respected. The second capacitor is screen printed outside the center of the loops to prevent damaging transverse currents and therefore adversely affecting the inductance of the antenna. Consequently, this second capacitor is easily connected to the outer contact zone of the antenna. To connect it to the inner contact zone of the antenna, however, it is necessary to create an insulating bridge on top of the loops at the level of which a conductive link can then be screen printed.

The creation of this bridge is constraining and adds additional steps to the antenna manufacturing process. With the screen printing technique, the capacitors that can be obtained have an intermediate capacitance. This capacitance does not totally compensate for the reduction in the internal capacitance of the chip. Consequently, in order for the resonance law to be respected, it is necessary to increase the inductance of the antenna, which is obtained by increasing the number of loops, and by imposing the creation of a bridge to connect this multiloop antenna to the second screen printed capacitor.

In the prior art, capacitors having a higher capacitance are known, which can cooperate with a single-loop antenna. But in this case such capacitors are expensive, take up too much space and negate cost-reduction efforts.

The object of the invention is to resolve the problems mentioned and permits the manufacture of planar antennas at low cost and in high volume, taking into account future technical constraints imposed by chip manufacturers. According to the invention, it is possible to propose an antenna preferably having a single loop on the same support, this antenna being connected to a high-capacitance capacitor. The capacitance of a flat capacitor is deduced from the following equation:
C=ε₀*εᵣ*S/e wherein

C is the capacitance value,

ε₀ corresponds to the dielectric constant of the vacuum (8.854·10¹² F/m),

εᵣ corresponds to the relative dielectric constant,

S corresponds to the surface of the electrodes facing one another, and

e corresponds to the thickness of the dielectric.

In the invention, a high-capacitance capacitor is obtained by principally working with the thickness value of the dielectric that is positioned between the two conductive plates. In order to obtain the result of the invention, the capacitor is printed by gravure printing on the support that also bears the antenna. In fact, by the gravure printing technique, a deposit of a very thin film is obtained. The capacitor is obtained by deposit of at least three superimposed and successive layers, such as a first conductive film, covered with a second insulating film, and finally, the insulating film covered by a third conductive film. For example, the antenna can itself be printed by gravure printing at this time, the design of the antenna being finalized with the two conductive layers.

Gravure printing is a technique derived from copperplate engraving. The printing elements are hollow. The printing zones are engraved on a steel cylinder coated with copper and chromium-plated. Chemical solutions can be used to engrave the copper. There are also machines that mechanically engrave the cylinders by means of a diamond point by electronic scanning of a photograph to be reproduced. Finally, another preparation method for the printing cylinders uses a laser for the engraving. During printing, the ink fills the openings of the cylinder, a scraper removes the excess ink and the support is then pressed against the printing form to carry out the printing. The impression that results from this is of high quality and is perfectly reproducible. Gravure printing uses fluid inks containing volatile solvents. Even for deposits of small thickness, a deposit covering the entire surface to be printed in a homogeneous manner is obtained.

The advantages associated with this process permit guaranteeing a constant geometry of the flat capacitor. Due to the fact that this capacitor has a high capacitance, even a single-loop antenna is tuned to resonance. Consequently, the capacitor and the chip can be very easily connected to the single-loop antenna. The overall electrical resistance of the single-loop antenna is lower than the resistance of a classical loop. This permits envisioning in one variant, a high-speed electrolytic copper deposition with a constant and controlled thickness, on top of each of the zones bearing a portion of the conductive film.

Thus the inventive process permits reducing very appreciably the transponder price by acting simultaneously on the direct manufacturing cost of the antenna and by a simplification of the chip micropackaging.

The subject of the invention is a coupling antenna comprising at least one loop present on a support, and connected to a capacitor present on this same support, the capacitor being mounted in parallel onto two contact zones of the antenna, characterized in that the antenna and the capacitor are printed by gravure printing onto the same support.

The subject of the invention is also a production process for an antenna comprising at least one loop connected to a capacitor, the antenna and the capacitor being present on the same insulating support characterized in that it comprises the following steps:

creating a first printing by gravure printing with a conductive ink to obtain an open loop of the antenna, a lower electrode of the capacitor, and a connection between a first contact zone of the antenna and the lower electrode,

creating a second printing by gravure printing with a dielectric ink to cover the lower electrode with an insulating film,

creating a third printing by gravure printing with a conductive ink to obtain an upper electrode for the capacitor covering the insulating film, and to obtain a connection between a second contact zone of the antenna and the upper electrode.

The invention will be better understood upon reading the description that follows and examining the figures that accompany it. These figures are only shown by way of indication and do not at all limit the invention. The figures show:

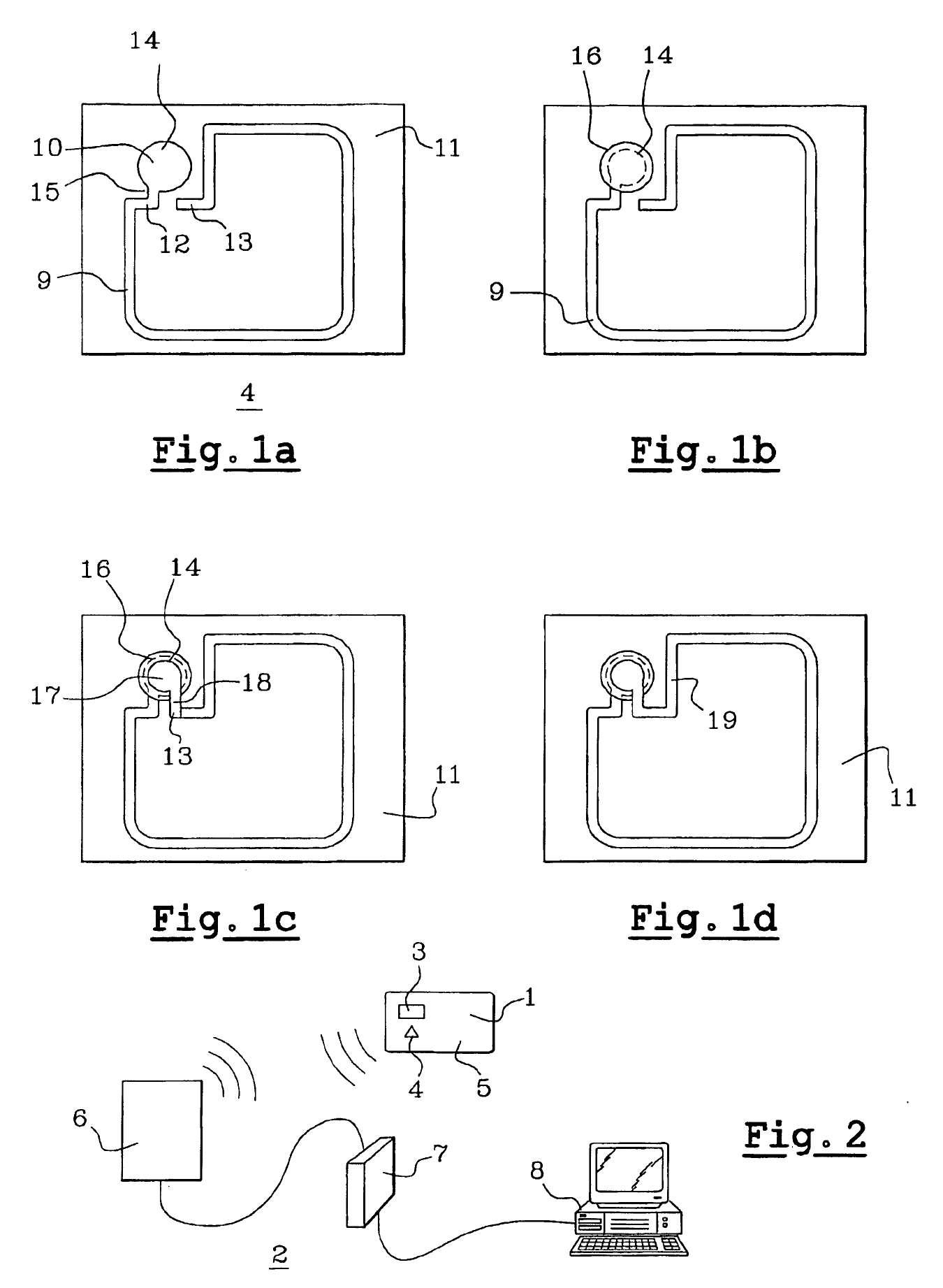

FIG. 1a: a top view of a support after a first step of the process according to the invention,

FIG. 1b: a top view of a support after a second step of the process according to the invention,

FIG. 1c: a top view of a support after a third step of the process according to the invention,

FIG. 1d: a top view of a support after a last optional step of the process according to the invention,

FIG. 2: an overall view of an antenna according to the invention cooperating with a reading device.

FIG. 2 shows a mobile device 1 provided to exchange radioelectric signals with a reading device 2. Mobile device 1 is a transponder comprising an electronic microcircuit 3, or chip 3, and an antenna 4. For example, chip 3 and antenna 4 are present on an insulating substrate 5. This substrate 5 can, for example, have the forms of a standard ISO-format chip card. Chip 3 is connected to antenna 4, and is supplied by the induced current produced by the electromagnetic field transmitted and received in antenna 4.

Reading device 2 comprises a second antenna 6 to transmit and receive signals in the direction of mobile device 1. Moreover, device 2 comprises a coupler 7 linked to the second antenna 6, this coupler 7 being also linked to a management and processing unit 8 for the data exchanged. Unit 8 is, for example, a computer.

According to the invention, antenna 4 comprises, as shown in FIGS. 1a, 1b, 1c, and 1d, at least one loop 9 and a capacitor 10 mounted in parallel with loop 9. Loop 9 and capacitor 10 are present on a support 11. Support 11 is insulating and can, for example, be present in the form of a flexible thick film. For example, substrate 11 is of the polyethylene (PE), polyester (PET), polyvinyl chloride (PVC), polycarbonate (PC), acrylonitrile-butadiene-styrene (ABS), glass-epoxy, polyimide, or paper type, etc.

Loop 9 comprises a first contact zone 12 and a second zone 13 to which capacitor 10 and chip 3 will be connected.

During a first step of the manufacturing process of antenna 4 according to the invention, support 11 is positioned under a first gravure printing cylinder supplied with electrically conductive ink. A first pattern which draws loop 9, a lower electrode 14 of capacitor 10, and a connection 15 between first contact zone 12 and lower electrode 14 is thus created. The second contact zone 13 also appears from the deposit of the first layer of conductive ink. For example, the thickness of the ink deposit, once dried, is of the order of 2 to 4 micrometers.

In order to form capacitor 10, a second film 16 is deposited with a dielectric material on top of lower electrode 14. According to the invention, this second film 16 is deposited by gravure printing by means of a second cylinder supplied with an ink with insulating properties. Preferably, this second film is obtained after a double passage under two cylinders such as the second cylinder. Thus, dielectric film 16 is obtained by two superimposed films of insulating ink. With such a double thickness of the insulating films, problems of porosity in the dielectric that separates lower electrode 14 from upper electrode 17 are prevented.

Typically, the thickness of insulating film 16 is less than 10 micrometers, and preferably varies between 5 and 10 micrometers, this film 16 being preferably obtained in two successive layers in order to limit porosity that would generate current leaks. The dielectric film is homogeneous, and does not have pores in which impurities could be lodged.

With gravure printing technology, and the specific ink used, in one variant, film 16 can be obtained in a single passage under the second cylinder.

Then, in order to finish capacitor 10, as FIG. 1c shows, a third film is deposited, in order to form upper electrode 17, as well as a connection 18 between this upper electrode 17 and second contact zone 13. This third film is printed by gravure printing by using conductive ink. In this case, a four-color machine is used, which has four cylinders within the same line.

Preferably the same conductive ink is used to create the first film and the third film. The ink used in the invention has a very low electrical resistance; it comprises copper, silver, gold, palladium, tin, or alloys of the latter as well as conductive polymers. The electrically conductive ink must be prepared, from the point of view of its viscosity and from the point of view of other physiochemical properties, in the appropriate manner for gravure printing.

The ink chosen is, for example, an electrically conductive metal-filled ink. In this case the metal is principally silver, and is present in the form of flakes forming microplates. These microplates are preferably of very small thickness (1 to 2 μm) and of a length comprised between 2 and 5 μm. The proportion of these metal fillers is comprised between 50 and 80% of the solid ink mass. Preferably, the proportion of metal filler is 70%, in order to guarantee a high conductivity of the ink thus formed. The high-conductivity ink is counterbalanced with low resistivity, which facilitates the following metallization step.

In one variant, the ink can comprise conductive organic polymers. The advantage of these polymers is that they are formulated in a solvent or aqueous phase, which thus permits adjusting the rheological properties of the ink obtained, notably in order to render it compatible with the gravure printing process. Another advantage comes from the fact that in this variant, the ink does not comprise metal fillers, which contributes to a large-scale cost reduction, and which facilitates obtaining a homogeneous ink that permits making the manufacturing process reliable.

During a last step, a metal film 19 can be deposited, for example, in order to cover all the portions having conductive ink whether from the first passage or the third passage. This metal layer can be deposited by electrolytic copper-plating. The copper thickness deposited is of the order of 5 micrometers and covers loop 9, contact zones 12 and 13, connections 15 and 18, and also the upper face 17 of the upper electrode of capacitor 10.

Preferably, to tune antenna 4 with chip 3 at the frequency of 13.56 MHz, a loop 9 of width 500 μm is chosen, such that it has an inductance of 270 nH. Then, the capacitance of the external flat capacitor 10 that must be provided on support 11 is determined, as a function of the internal capacitance of chip 3. For example, in the case where the capacitance of chip 3 is 97 pF, given that a thickness of 8 micrometers for the dielectric can be reliably obtained, a diameter of the electrodes equal to 11.8 millimeters is chosen. In one variant, if the capacitance of chip 3 is 25 pF, it is then necessary that flat capacitor 10 has a capacitance of 485 pF, and for this purpose, when one has a dielectric thickness of 8 micrometers, a capacitor surface is provided so that the diameter equals 12.8 millimeters.

In one variant, in the invention, notably if a single dielectric film 16 suffices, since the thickness is reduced, antenna models can be provided for electronic labels with capacitors 10 of very small size.

1. A coupling antenna comprising at least one loop present on a support, and connected to a capacitor present on this same support, the capacitor being mounted in parallel on both contact zones of the antenna, characterized in that the antenna and the capacitor are printed by gravure printing on the same support.

2. The antenna according to claim 1, further characterized in that the antenna comprises a single loop and is tuned to a medium-frequency carrier wave for transmission and reception.

3. The antenna according to claims 1, further characterized in that the antenna is tuned for a frequency of around 13.56 MHz.

4. The antenna according to claims 1, further characterized in that an insulating thickness between two electrodes of the flat capacitor is less than 10 micrometers.

5. The antenna according to one of claims 1, further characterized in that it is connected to an electronic chip.

6. A production process for an antenna comprising at least one loop connected to a capacitor, the antenna and the capacitor being present on the same insulating support, characterized in that it comprises the following steps:
creating a first gravure printing of a conductive ink in order to obtain an open loop of the antenna, a lower electrode of the capacitor, and a connection between a first contact zone of the antenna and the lower electrode,
creating a second printing by gravure printing with a dielectric ink to cover the lower electrode with an insulating film,
creating a third printing by gravure printing with a conductive ink to obtain an upper electrode for the capacitor covering the insulating film, and to obtain a connection between a second contact zone of the antenna and the upper electrode.

7. The process according to claim 6, further characterized in that the insulating film is obtained by successive deposition of two dielectric ink layers printed by gravure printing.

8. The process according to one of claims 6, further characterized in that it comprises a final step consisting of:
depositing a metallized film by electrolysis onto the conductive ink layers belonging to the open loop of the antenna, the connection between the first contact zone of the antenna and the lower electrode, the upper electrode and the connection between the second contact zone of the antenna and this upper electrode.

9. The process according to claims 6, further characterized in that the surface of the capacitor to be printed by gravure printing is determined as a function of the thickness of the dielectric layer that can be deposited during the second printing.

10. The process according to claims 6, further characterized in that the two contact zones of the antenna are directly connected to an electronic chip with which the antenna cooperates.
